(19) United States
(12) Patent Application Publication
(10) Pub. No.: US 2012/0192545 A1
(43) Pub. Date: Aug. 2, 2012

(54) Pulse Detonation Combustor Nozzles

(75) Inventors: Venkat Eswarlu Tangirala, Niskayuna, NY (US); Narendra Joshi, Schenectady, NY (US)

(73) Assignee: GENERAL ELECTRIC COMPANY, Schnectady, NY (US)

(21) Appl. No.: 13/015,614

(22) Filed: Jan. 28, 2011

(51) Int. Cl. F02K 5/02

(52) U.S. Cl. 60/247

(57) ABSTRACT

The present application provides a pulse detonation engine. The pulse detonation engine may include a number of pulse detonation combustors. Each of the pulse detonation combustors may include a combustion tube and a nozzle assembly. The nozzle assembly of one or more of the pulse detonation combustors may include a diffuser therein.

### TECHNICAL FIELD

The present application relates generally to pulse detonation combustors and more particularly relates to pulse detonation combustor nozzles that may suppress undesirable cross tube wave interactions as well as provide increased cooling and performance.

### BACKGROUND OF THE INVENTION

Recent developments with pulse detonation combustors and engines have focused on practical applications such as generating additional thrust/propulsion for aircraft engines and to improve overall performance in ground-based power generation systems. Known pulse detonation combustors and engines generally operate with a detonation process having a pressure rise as compared to conventional engines operating with a constant pressure deflagration. Specifically, air and fuel are mixed within a pulse detonation chamber and ignited to produce a combustion pressure wave. The combustion pressure wave transitions into a detonation wave followed by combustion gases that produce thrust as they are exhausted from the engine. As such, pulse detonation combustors and engines have the potential to operate at higher thermodynamic efficiencies than generally may be achieved with conventional deflagration-based engines.

Pulse detonation engines generally use multiple combustor tubes. One challenge in designing multi-tube pulse detonation engines is optimizing the downstream tube and nozzle geometry. For example, downstream shock interactions of one combustor tube may adversely impact on the operability of the neighboring tubes. Specifically, the shock may propagate into an adjacent tube so as to disturb the cycle therein and diminish overall engine efficiency.

Further, metal temperatures within the nozzles of the combustor tubes may exceed predetermined values during a typical operation cycle. Providing nozzle cooling, however, may be difficult and may necessitate the diversion of upstream compressed airflows. These upstream flows may be considered “expensive” in that they may impact overall engine efficiency.

There is therefore a desire for improved nozzle designs for pulse detonation combustors and pulse detonation engines and the like. Preferably such an improved nozzle design may limit possibly damaging cross-tube interactions as well as provide cooling therein without the use of complicated or expensive control and cooling systems and the like that may negatively impact on overall combustor or engine efficiency.

### SUMMARY OF THE INVENTION

The present application thus provides a pulse detonation engine. The pulse detonation engine may include a number of pulse detonation combustors. Each of the pulse detonation combustors may include a combustion tube and a nozzle assembly. The nozzle assembly of one or more of the pulse detonation combustors may include a diffuser therein.

The present application further provides a pulse detonation combustor. The pulse detonation combustor may include a combustion tube and a cooling nozzle at a downstream end of the cooling tube. The cooling nozzle may include a number of cooling protrusions positioned thereon.

The present application further provides a pulse detonation engine. The pulse detonation engine described herein may include a number of pulse detonation combustors. Each of the pulse detonation combustors may include a combustion tube and a nozzle assembly. The nozzle assembly may include a number of cooling protrusions formed therein.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a side cross-sectional view of a known pulse detonation combustor.

FIG. 2 is a schematic view of known pulse detonation engine with a number of pulse detonation combustors.

FIG. 3 is a side plan view of a pulse detonation combustor as may be described herein with a nozzle assembly having a shock diffuser.

FIG. 4 is a side cross-sectional view of a portion of an alternative embodiment of a pulse detonation combustor with an internal cooling nozzle.

FIG. 5 is a side plan view of a portion of an alternative embodiment of a pulse detonation combustor with an exterior cooling nozzle.

### DETAILED DESCRIPTION

As used herein, the term “pulse detonation combustor” refers to a device or a system that produces both a pressure rise and a velocity increase from the detonation or quasi-detonation of a fuel and an oxidizer. The pulse detonation combustor may be operated in a repeating mode to produce multiple detonations or quasi-detonations within the device. A “detonation” may be a supersonic combustion in which a shock wave is coupled to a combustion zone. The shock may be sustained by the energy release from the combustion zone so as to result in combustion products at a higher pressure than the combustion reactants. A “quasi-detonation” may be a supersonic turbulent combustion process that produces a pressure rise and a velocity increase higher than the pressure rise and the velocity increase produced by a sub-sonic deflagration wave. For simplicity, the terms “detonation” or “detonation wave” as used herein will include both detonations and quasi-detonations.

Exemplary pulse detonation combustors, some of which will be discussed in further detail below, include an ignition device for igniting a combustion of a fuel/oxidizer mixture and a detonation chamber in which pressure wave fronts initiated by the combustion coalesce to produce a detonation wave. Each detonation or quasi-detonation may be initiated either by an external ignition source, such as a spark discharge, laser pulse, heat source, or plasma igniter, or by gas dynamic processes such as shock focusing, auto-ignition, or an existing detonation wave from another source (cross-fire ignition). The detonation chamber geometry may allow the pressure increase behind the detonation wave to drive the detonation wave and also to blow the combustion products themselves out an exhaust of the pulse detonation combustor. Other components and other configurations may be used herein.

Various chamber geometries may support detonation formation, including round chambers, tubes, resonating cavities, reflection regions, and annular chambers. Such chamber designs may be of constant or varying cross-section, both in area and shape. Exemplary chambers include cylindrical tubes and tubes having polygonal cross-sections, such as, for example, hexagonal tubes. As used herein, “downstream” refers to a direction of flow of at least one of the fuel or the oxidizer.

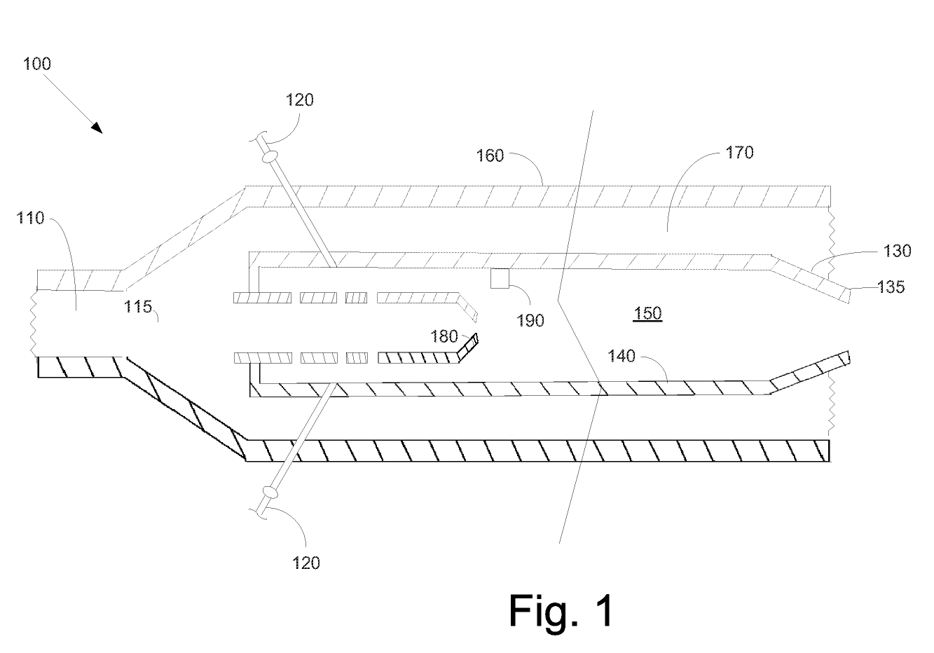

Referring now to the drawings, in which like numbers refer to like elements throughout the several views, FIG. 1 shows a generalized example of a pulse detonation combustor 100 as may be described and used herein. The pulse detonation combustor 100 may extend from an upstream head end 115 that includes an air inlet 110 and one or more fuel inlets 120 to an exit nozzle 130 at an opposed downstream end 135. A combustion tube 140 may extend from the head end 115 to the nozzle 130 at the downstream end 135. The combustion tube 140 defines a combustion chamber 150 therein. A casing 160 may surround the combustor tube 140. The casing 160 may be in communication with the air inlet end 110 at the head end 115 and may extend to or beyond the nozzle 130 at the downstream end 135. The casing 160 and the combustion tube 140 may define a bypass duct 170 therebetween. Other components and other configurations may be used herein.

The air inlet 110 may be connected to a source of pressurized air such as a compressor. The pressurized air may be used to fill and purge the combustion chamber 150 and also may serve as an oxidizer for the combustion of the fuel. The air inlet 110 may be in communication with a center body 180. The center body 180 may extend into the combustion chamber 150. Likewise, the fuel inlet 120 may be connected to a supply filet that may be burned within the combustion chamber 150. The fuel may be injected into the chamber 150 so as to mix with the airflow.

An ignition device 190 may be positioned downstream of the air inlet 110 and the fuel inlet 120. The ignition device 190 may be connected to a controller so as to operate the ignition device 190 at desired times and sequences as well as providing feedbacks signals to monitor operations. As described above, any type of ignition device 190 may be used herein. The fuel and the air may be ignited by the ignition device 190 into a combustion flow so as to produce the resultant detonation waves. Also as described above, the detonation waves produced herein may have an impact on adjacent tubes 140. A portion of the airflow also may pass through the bypass duct 170. This portion of the airflow may serve to cool the tube 140 and the nozzle 130. Other components and other configurations may be used herein. Any type of pulse detonation combustor 100 may be used herein.

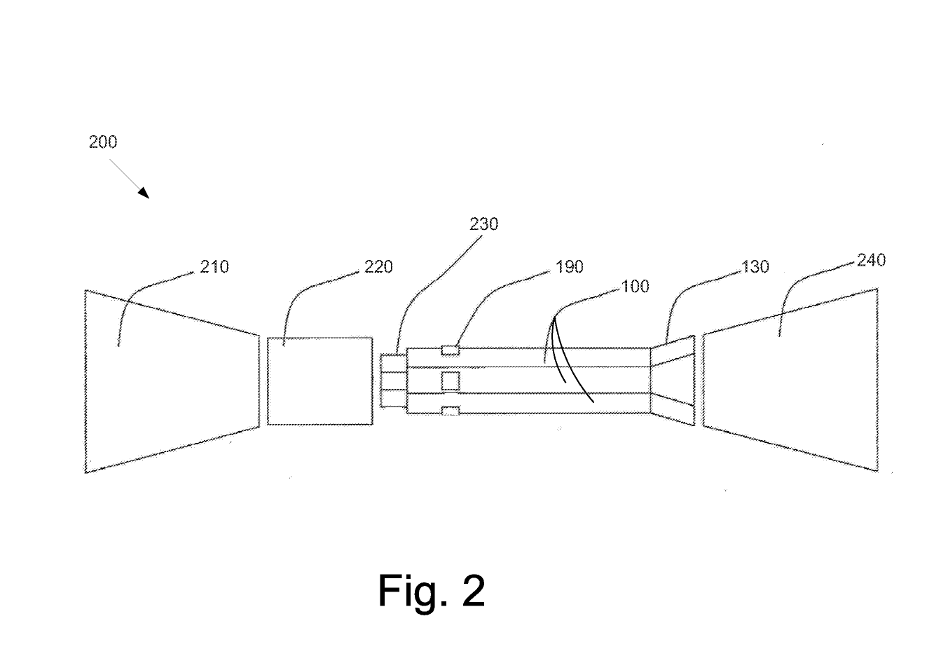

FIG. 2 shows a generalized example of a pulse detonation engine 200 using a number of the pulse detonation combustors 100. Generally described, the pulse detonation engine 200 may include a compressor 210 to compress an incoming flow of air. The compressor 210 may be in communication with an inlet system 220 with a number of inlet valves 230. Each inlet valve 230 may be in communication with a pulse detonation combustor 100 as described above so as to mix the compressed flow of air with a flow of fuel for combustion therein. The pulse detonation combustors 100 may be in communication with a turbine 240 via the nozzles 130 or other type of plenum. The hot combustion gases from the pulse detonation combustors 100 drive the turbine so as to produce mechanical work. Other configurations and other components may be used herein. Any type of pulse detonation engine 200 may be used herein with any number or type of pulse detonation combustors 100.

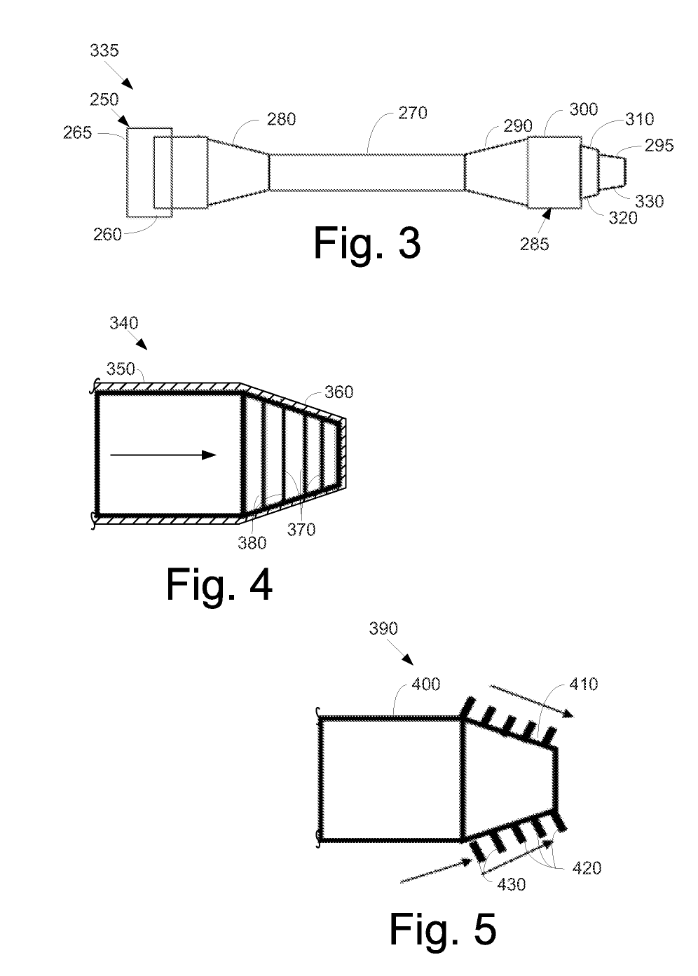

FIG. 3 shows a portion of a pulse discharge combustor 250 as may be described herein. As above, the pulse discharge combustor 250 may include an inlet valve 260 at a head end 265 thereof. The inlet valve 250 may be in communication with a combustion tube 270. The inlet valve 260 and the combustion tube 270 may be separated by a converging section 280. As above, the air inlet 110 and the fuel inlet 120 may be in communication with the pulse discharge combustor 250. Likewise, an ignition device 190 may be positioned within the combustion tube 270. The pulse discharge combustor 250 may have any desired internal configuration. Other components also may be used herein.

The pulse discharge combustor 250 may have a nozzle assembly 285 at a downstream end 295 of the tube 270. The nozzle assembly 285 may include a diverging section 290 at the downstream end 295 of the combustion tube 270. The diverging section 290 may have any desired size or shape. A shock diffuser 300 may be positioned adjacent to the diverging section 290. Although the shock diffuser 300 is shown has having an extended cylindrical shape, the shock diffuser 300 may have any desired size or shape. The shock diffuser 300 may act to suppress pressure perturbations leaving the combustion tube 270. Moreover, the shock diffuser 300 may suppress disturbances from outside the pulse discharge combustor 250 from other combustors and the like from entering into the combustion tube 270. A sub-sonic diffuser and the like also may be used herein.

The nozzle assembly 285 also may have an exit plenum 310 positioned downstream of the shock diffuser 300. In this example, the exit plenum 310 may have a first nozzle converging section 320 and a second nozzle converging section 330. The exit plenum 310 may have any size or shape and any number of sections 320, 330. Other configurations and other components may be used herein.

Multiple pulse detonation combustors 250 may be used together as in a pulse detonation engine 335 similar to that described above. The use of the shock diffuser 300 on the combustion tube 270 of the pulse detonation combustor 250 thus minimizes detrimental cross tube interactions. Specifically, the shock diffuser 300 minimizes the harmful effects on operability and performance of the pulse detonation combustors 250 due to propagation of waves from one combustion tube to another. The shock diffuser 300 does so by suppressing high pressure perturbations leaving each combustion tube 270 and suppressing disturbances from outside each combustion tube 270 from entering therein. The shock diffuser 300 thus may improve overall system efficiency and well as improve overall system safety, lifetime, and performance.

FIG. 4 shows a further embodiment of a pulse detonation combustor 340 as may be described herein. In this example, the pulse detonation combustor 340 may include a combustion tube 350 leading to a cooling nozzle 360. As above, the air inlet 110 and the fuel inlet 120 may be in communication with the pulse discharge combustor 340. Likewise, an ignition device 190 may be positioned within the combustion tube 350. The pulse discharge combustor 340 may have any desired internal configuration. Other components also may be used herein.

In this example, the cooling nozzle 360 may have a number of internal cooling protrusions 370 therein. Although the internal cooling protrusions 370 are shown herein as a number of fins 380, the internal cooling protrusions may have any desired two-dimensional or three-dimensional shape or orientation. For example, the internal cooling protrusions 370 thus may include fins, baffles, dimples, or other type of configuration. The internal cooling protrusions 370 may be largely axis-symmetric. Any number of the internal cooling protrusions 370 may be used herein in any desired size or shape.

As referenced above, nozzle metal temperatures may exceed predetermined limits during the periodic cycle operation of the pulse discharge combustor 340. There is a period of time that during a pulse detonation engine cycle, however, in which the flow through the nozzle may be at about the same temperature as the inlet temperature. The cooling nozzle 360 described herein thus may use the internal cooling protrusions 370 so as to increase the inner surface area and volume of the cooling nozzle 360. The increased surface area and volume thus provides increased heat transfer such that nozzle metal temperatures may be reduced. Likewise, the internal cooling protrusions 370 of the cooling nozzle 360 may suppress heat transfer to the upstream of the pulse discharge combustor 340 so as to improve performance and reduce the overall heat transfer to the inlet gas. Other components and other configurations may be used herein.

FIG. 5 shows a further embodiment of a pulse discharge combustor 390 as may be described herein. In this example, the pulse detonation combustor 390 may include a combustion tube 400 leading to a cooling nozzle 410. As above, the air inlet 110 and the fuel inlet 120 may be in communication with the pulse discharge combustor 390. Likewise, an ignition device 190 may be positioned within the combustion tube 400. The pulse discharge combustor 390 may have any desired internal configuration. Other components also may be used herein.

In this example, the cooling nozzle 410 may include a number of external cooling protrusions 420. Although the external cooling protrusions 420 are shown as a number of fins 430, the external cooling protrusions 420 may have any desired two-dimensional or three-dimensional shape or orientation. For example, the external cooling protrusions 420 thus may include fins, baffles, dimples, or other type of configuration. The external cooling protrusions 420 may be largely axis-symmetric. Any number of the external cooling protrusions 420 may be used herein in any desired size or shape. The external cooling protrusions 420 improve the heat transfer from the nozzle 410 to the cooling flow within the bypass duct 170. Other components and other configurations may be used herein.

The internal cooling protrusions 370 of the cooling nozzle 360 also may be used with the external cooling protrusions 420 of the cooling nozzle 410. Both nozzles 360, 410 thus may enhance heat transfer from the nozzle to either the cold purge gas flow or the external cooling flow. Overall performance likewise may be improved as heat is recycled back to the primary flow through the combustion tube while less heat is transported to the incoming gas flow. Some or all of the cooling protrusions 370, 420 of the cooling nozzles 360, 410 also may be used with the shock diffuser 300 of the nozzle assembly 285.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A pulse detonation engine, comprising:
a plurality of pulse detonation combustors;
each of the plurality of the pulse detonation combustors comprising a combustion tube and a nozzle assembly; and
wherein the nozzle assembly of one or more of the plurality of pulse detonation combustors comprise a diffuser therein.

2. The pulse detonation engine of claim 1, wherein the nozzle assembly comprises a diverging section upstream of the diffuser.

3. The pulse detonation engine of claim 1, wherein the nozzle assembly comprises an exit plenum downstream of the diffuser.

4. The puke detonation engine of claim 3, wherein the exit plenum comprises one or more converging sections.

5. The pulse detonation engine of claim 1, wherein each of the plurality of pulse detonation combustors comprises an inlet valve upstream of the combustion tube.

6. The pulse detonation engine of claim 1, wherein each of the plurality of pulse detonation combustors comprises a converging section upstream of the combustion tube.

7. The pulse detonation engine of claim 1, wherein the nozzle assembly comprises a plurality of internal cooling protrusions.

8. The pulse detonation engine of claim 1, wherein the nozzle assembly comprises a plurality of external cooling protrusions.

9. A pulse detonation combustor, comprising:
a combustion tube; and
a cooling nozzle at a downstream end of the cooling tube;
wherein the cooling nozzle comprises a plurality of cooling protrusions positioned thereon.

10. The pulse detonation combustor of claim 9, wherein the plurality of cooling protrusions comprises a plurality of internal cooling protrusions.

11. The pulse detonation combustor of claim 9, wherein the plurality of cooling protrusions comprises a plurality of external cooling protrusions.

12. The pulse detonation combustor of claim 9, wherein the plurality of cooling protrusions comprises a plurality of internal cooling protrusions and a plurality of external cooling protrusions.

13. The pulse detonation combustor of claim 9, wherein the plurality of cooling protrusions comprises a plurality of fins.

14. The pulse detonation combustor of claim 9, further comprising a bypass duct surrounding the combustion tube and the cooling nozzle.

15. The pulse detonation combustor of claim 9, further comprising a diffuser positioned downstream of the combustion tube.

16. A pulse detonation engine, comprising:
a plurality of pulse detonation combustors;
each of the plurality of the pulse detonation combustors comprising a combustion tube and a nozzle assembly; and
wherein the nozzle assembly comprises a plurality of cooling protrusions therein.

17. The pulse detonation engine of claim 16, wherein one or more of the plurality of pulse detonation combustors comprise a diffuser therein.

18. The pulse detonation engine of claim 16, wherein the plurality of cooling protrusions comprises a plurality of internal cooling protrusions.

19. The pulse detonation engine of claim 16, wherein the plurality of cooling protrusions comprises a plurality of external cooling protrusions.

20. The pulse detonation engine of claim 16, wherein the plurality of cooling protrusions comprises a plurality of fins.
